(19) United States
(12) Patent Application Publication
(10) Pub. No.: US 2005/0284851 A1
(43) Pub. Date: Dec. 29, 2005

(54) Method and apparatus for manufacturing vehicle lamps

(75) Inventors: Masahiro Enoki, Shizuoka (JP); Fujihiko Sugiyama, Shizuoka (JP); Ryosuke Yasuda, Shizuoka (JP); Kazuhiro Yamazaki, Shizuoka (JP)

Correspondence Address: OSHA LIANG L.L.P., 1221 MCKINNEY STREET, SUITE 2800, HOUSTON, TX, 77010, US

(73) Assignee: KOITO MANUFACTURING CO., LTD., Tokyo (JP)

(21) Appl. No.: 11/153,060

(22) Filed: Jun. 15, 2005

(30) Foreign Application Priority Data
Jun. 23, 2004 (JP) JP2004-185466

(51) Int. Cl. B23K 26/00

(52) U.S. Cl. 219/121.64

(57) ABSTRACT

A vehicle lamp is provided with a lens and a housing. The housing is opened in a front side thereof. The lens is fixed to the housing by laser-beam welding so that the lens covers the front side opening of the housing. The lens is fixed to the housing by bringing the lens, around a full circumference of which laser beam transmitting portions and welding portions are formed, into abutment with the housing, around a full circumference of which a welding portions is formed. The lens is pressed by a press holding jig having a laser beam transmitting portion so as to bring the welding portions of the lens into abutment with the welding portions of the housing. A laser beam is emitted to at least a part of a location where the welding portions of the lens are in abutment with the welding portions of the housing. The laser beam is transmitted through the laser beam transmitting portion of the press holding jig and the laser beam transmitting portion of the lens to at least part of the location. In a segment where the part of the location continues, a sum of a thickness of the laser beam transmitting portion of the press holding jig and a thickness of the laser beam transmitting portion of the lens remains substantially constant in a direction in which the laser beam is scanned.

The present application claims foreign priority based on Japanese Patent Application No. P.2004-185466, filed on Jun. 23, 2004, the contents of which are incorporated herein by reference.

### BACKGROUND OF THE INVENTION

1. Field of the Invention

The present invention relates to a method and apparatus for manufacturing vehicle lamps, and more particularly to a technique for ensuring a connection between a lens and a housing.

2. Related Art

In manufacturing vehicle lamps such as automotive lamps, a process is necessary for attaching a lens to a housing in such a manner as to cover a front side opening of the housing.

There is one method, when attaching a lens to a housing, in which sealing legs are provided at a circumferential edge portion of the lens in such a manner as to protrude therefrom, grooves for receiving the sealing legs are formed in the housing, and the sealing legs on the lens are received in the grooves in the housing via a sealing material or adhesive material. In the attaching method, however, since the sealing legs and the grooves are provided at portions which protrude from the circumferential edge portions of the lens and the housing, portions are produced around the circumferential edge portions thereof which do not transmit light or which look dark, when the lens is viewed from the front, leading to a problem that the light emitting area becomes small for its total size.

Then, there was devised a method for directly joining sealing legs of a lens to a joining surface of a housing. When the sealing legs of the lens are attempted to be joined directly to the housing, there needs a joining margin of only a small width, and hence, the portions around the circumferential edge portion of the lens which look dark can be reduced to an extremely narrow width. Then, there have been generally used hot plate welding, vibration welding and the like as the direct joining method.

In these methods, while the joining portions between the lens and the housing are joined together by being cooled to set in such a state that portions of the lens and the housing where the materials thereof are fused are mixed with each other, the redundant fused materials are pushed aside from the joined locations. This triggers a problem that when these materials are seen through the lens from the front, the external appearance of the lamp is damaged. In addition, since there is imposed a limitation on shapes of lamps (such as limitation on the inclination angle; in the vibration welding, the joining portions need to be flat relative to the direction in which vibrations are generated, and in the hot plate welding, the joining portions cannot be inclined extremely relative to the direction in which the hot plate is brought into press contact with the lens), these methods cannot deal with the currently adopted three-dimensional designs.

In addition, there is a method for joining a lens and a housing together using laser-beam welding. In the laser-beam welding, the fusing state of the materials or irradiation energy at a joining portion can be controlled to be constant by controlling the output of a laser beam, the diameter of a laser beam spot at the joining portion, and the scanning speed. Thus, it is possible to avoid the protrusion of the fused materials due to excessive fusion or joining failure due to fusion failure.

Incidentally, in the laser-beam welding, in the event that a welding portion of a lens and a welding portion of a housing are not in contact with each other in an ensured fashion, a joining failure occurs. Many automotive lamps are large in size, and hence, it becomes difficult to ensure that the welding portions (joining portions), which have a width of on the order of 2 to 5 mm, of the lens and the housing are kept in contact with each other only by placing the lens on the housing.

To cope with this, it is considered that the lens is pressed against the housing using a press holding jig. However, when attempting to press against a portion on the welding portion of the lens with the press holding jig, the press holding jig disturbs the irradiation of the welding portion, and a laser beam cannot be emitted through the lens. However, even in the event that a portion of the lens other than the circumferential edge portion thereof (the portion on the welding portion) is pressed against to avoid the disturbance by the press holding jig, since there exists a space between the portion of the lens excluding the circumferential edge portion thereof and the housing, the pressing of the other portion of the lens than the circumferential edge portion thereof results in an unbalanced application of stress to the entirety of the circumferential edge portion. This may positively trigger a risk that the welding portion of the lens and the welding portion of the housing fail to be kept in contact with each other partially along the full circumference of the circumferential edge portion.

Accordingly, it is considered that a material which can transmit a laser beam is used for the press holding jig so that a laser beam is emitted through the press holding jig. While it was described before that the fusion state of the materials could be controlled by controlling the output of the laser beam, the diameter of the laser beam spot, and the scanning of the laser beam, the spot diameter of the laser beam at the joining portion changes depending on a distance through which the laser beam is transmitted due to the refraction index of the press holding jig. Thus, it is difficult to control the spot diameter to be constant. In particular, it almost never happens with vehicle lamps that the lens exists on the same plane over the full circumference thereof, and on the contrary, the lens typically has a concave surface and/or a convex surface. In such cases, it becomes extremely difficult to maintain constant the irradiation energy at the joining surfaces.

### SUMMARY OF THE INVENTION

In accordance with one or more embodiments of the present invention, a vehicle lamp manufacturing method comprises the steps of bringing a lens, around a full circumference of which a laser beam transmitting portion and a welding portion are formed, into abutment with a housing, around a full circumference of which a welding portion is formed, at the welding portions pressing the lens with a press holding jig having a laser beam transmitting portion to bring the welding portion of the lens into abutment with the welding portion of the housing, and emitting a laser beam to a location where the welding portion of the lens is in abutment with the welding portion of the housing while the laser beam so emitted is made to be transmitted through the laser beam transmitting portion of the press holding jig and the laser beam transmitting portion of the lens at at least part of the location, wherein in a segment where the part of the location continues where the laser beam is transmitted through the laser beam transmitting portion of the press holding jig and the laser beam transmitting portion of the lens, a sum of the thickness of the laser beam transmitting portion of the press holding jig and the thickness of the laser beam transmitting portion of the lens remains substantially constant in a direction in which the laser beam is scanned.

In addition, in accordance with one or more embodiments of the present invention, a vehicle lamp manufacturing apparatus comprises a press holding jig for bringing a lens, around a full circumference of which a laser beam transmitting portion and a welding portion are formed, into abutment with a housing, around a full circumference of which a welding portion is formed, at the welding portions, wherein, when emitting a laser beam to a location where the welding portion of the lens is in abutment with the welding portion of the housing, the press holding jig allows the laser beam so emitted to be transmitted through the laser beam transmitting portion of the press holding jig and the laser beam transmitting portion of the lens at at least part of the location; and wherein in a segment where the part of the location continues where the laser beam is transmitted through the laser beam transmitting portion of the press holding jig and the laser beam transmitting portion of the lens, a sum of the thickness of the laser beam transmitting portion of the press holding jig and the thickness of the laser beam transmitting portion of the lens becomes substantially constant in a direction in which the laser beam is scanned.

Consequently, in one or more embodiments, in the segment where the part of the location continues where the laser beam is transmitted through the laser beam transmitting portion of the press holding jig and the laser beam transmitting portion of the lens, the distance over which the laser beam transmits through the laser beam transmitting portion of the press holding jig and the laser beam transmitting portion of the lens becomes substantially constant in a direction in which the laser beam is scanned.

Other aspects and advantages of the invention will be apparent from the following description and the appended claims.

### BRIEF DESCRIPTION OF THE DRAWINGS

FIG. 1 is a front view of a vehicle lamp manufactured according to an embodiment of the invention, which illustrates a method and apparatus used to manufacture the vehicle lamp according to one or more embodiments of the invention.

FIG. 2 is a sectional view showing a lens and a press holding jig in a separated state.

FIG. 3 is a sectional view taken along the line III-III in FIG. 1, which illustrates a condition where a laser-beam welding process is implemented.

FIG. 4 is a sectional view taken along the line IV-IV in FIG. 1, which illustrates a condition where a laser-beam welding process is implemented.

FIG. 5 is a plan view illustrating an example of laser scanning directions.

### REFERENCE NUMERALS AND CHARACTERS

1: vehicle lamp; 2: housing; 3: lens; 8: welding surface (welding portion) ; 9: laser beam transmitting portion; 10: welding surface (welding portion); 11: press holding jig; 12: surface abutment portion; 13: front surface; 14: positioning protruding edge (positioning portion); 16: laser beam transmitting portion; 18: laser beam; T9: thickness of the laser beam transmitting portion of the lens; T16: thickness of the laser beam transmitting portion of the press holding jig; tT: sum of the thickness of the laser beam transmitting portion of the lens and the thickness of the laser beam transmitting portion of the press holding jig.

### DESCRIPTION OF THE PREFERRED EMBODIMENTS

Next, embodiments of the invention will be described with reference to the accompanying drawings.

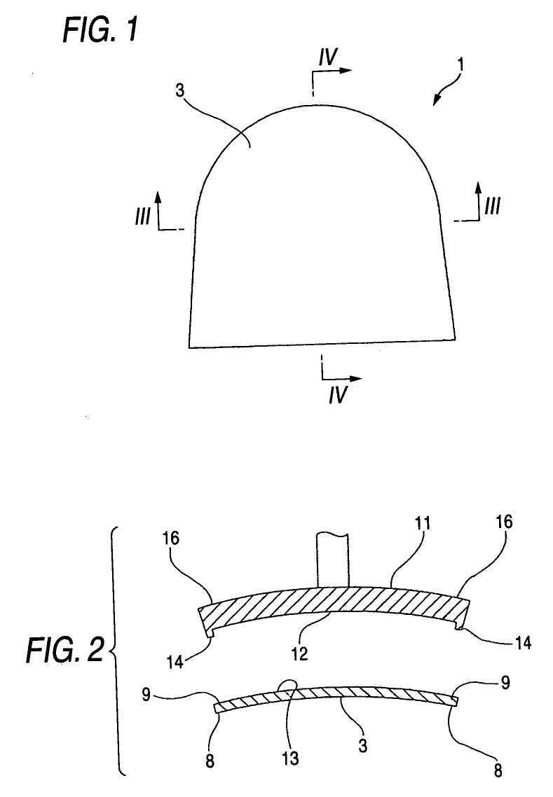

Referring to FIGS. 1 through 4, a vehicle lamp 1, a lens 3 is attached to a housing in such a manner as to cover an opening in a front side of the housing, and a light source unit, not shown, is disposed within a space 4 surrounded by the housing 2 and the lens 3.

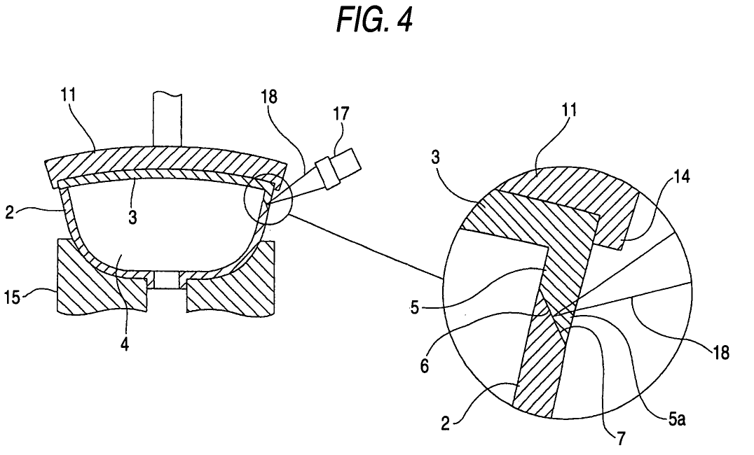

The housing 2 and the lens 3 are integrated into a single structure by virtue of laser-beam welding. Namely, as viewed from the front (referring to FIG. 1), at a portion of a lower edge of the lens 3 which extends substantially rectilinearly in a horizontal direction, a protruding portion 5 is formed in such a manner as to protrude rearwards from the lens 3. A rear end face 6 of the protruding portion 5 is made into an inclined plane which is displaced forward as it extends inwards. The inclined plane is made to constitute a welding surface. In association with this, a front-end edge of the housing which faces the protruding portion 5 of the lens 3 (referring to FIG. 4) is caused to recede rearwards more than front-end edges of the other portions of the housing by a distance equivalent to a longitudinal width of the protruding portion 5. A front surface 7 of the front-end edge is made into an inclined plane which is displaced forward as it extends inwards. The front surface 7 is made to constitute a welding surface. Thus, the welding surface 6 of the lens and the welding surface of the housing are inclined at the same inclination angle.

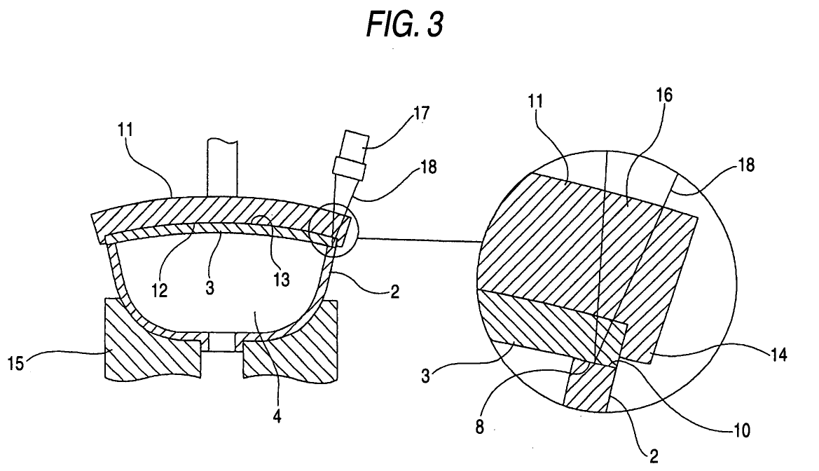

A welding surface 8, which is made to be substantially a horizontal surface, is formed on a lower surface of a circumferential edge portion of the lens 3 excluding the lower edge portion thereof. A portion 9 of the lens circumferential edge portion which is situated above the welding surface 8 is made to be a laser beam transmitting portion. A portion of the front-end edge of the housing 2 which faces the welding surface 8 of the lens 2 is made to be substantially a horizontal surface. The surface 10 is made to constitute a welding surface (referring to FIG. 3).

The housing 2 and the lens 3 are joined together by virtue of laser-beam welding in such a state that the welding surfaces 6 and 7 and the welding surfaces 8 and 10 are, respectively, brought into contact with each other.

When laser-beamwelding the housing 2 and the lens 3 together around the circumferential edge portions thereof, the lens 3 is pressed towards the housing 2 by means of a press holding jig 11 so as to ensure that the welding surfaces 6, 8 are brought into abutment with the welding surfaces 7, 10 of the housing 2, respectively.

The press holding jig 11 is formed into something like a thick plate-in such a size that can cover the entirety of a front side of the lens 3. A lower surface 12 of the press holding jig 11 is made as a surface abutment portion, and this surface abutment portion 12 is designed to be brought into abutment with the whole surface of a front surface 13 of the lens 3. Thus, since the surface abutment portion 12 of the press holding jig 11 is brought into abutment with the whole of the front surface 13 of the lens 3, even in the event that a warp or deflection occurs on the front surface portion of the lens 3 during molding, the warp or deflection can be eliminated, whereby it can be ensured that the whole of the welding surfaces 6, 8 of the lens 3 are brought into abutment with the welding surfaces 7, 10 of the housing 2.

In addition, a positioning protruding edge 14, which protrudes downwards, is provided on a lower surface of the press holding jig 11 in such a manner as to extend along a full circumference of a circumferential edge portion thereof, and the positioning protruding edge 14 is brought into abutment with the circumferential edge portion of the lens 3 from the outside, whereby the lens 3 is positioned relative to the press holding jig 11. Consequently, in the event that the housing 2 is disposed in such a state that the housing 2 is positioned relative to the press holding jig 11, the lens 3 is positioned relative to the housing 2, whereby it is ensured that the welding surface 6 of the lens 3 is brought into abutment with the welding surface 7 of the housing 2 and that the welding surface 8 of the lens 3 is brought into abutment with the welding surface 10 of the housing 2. Note that, in one or more embodiments, the housing 2 is placed on a table 15 which has been positioned relative to the press holding jig 11 to thereby position housing 2 relative to the press holding jig 11.

A circumferential edge portion 16 of the press holding jig 11 which excludes a lower edge portion thereof is made to be a laser beam transmitting portion. Namely, the circumferential edge portion 16 is made into a portion which is transparent and which transmits a laser beam. In one or more embodiments, the press holding jig 11 may be formed transparent only at the laser beam transmitting portion 16, however, in one or more embodiments, the whole of the press holding jig 11 may be formed of a transparent material.

As has been described above, after the housing 2, the lens 3 and the press holding jig 11 all have been set, a laser beam is emitted to the welding surfaces 6, 7, 8, 10 to perform laser-beam welding.

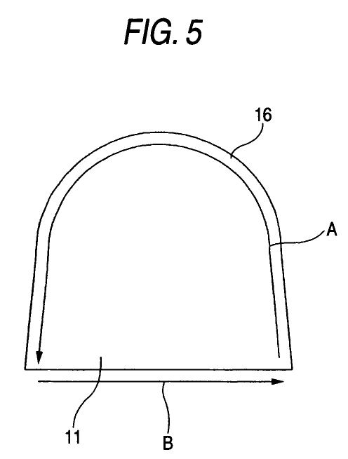

In one or more embodiments, the laser-beam welding of the welding surface 8 of the lens 3 with the welding surface 10 of the housing 2 is performed by scanning a laser beam as indicated by an arrow A shown in FIG. 5. As this occurs, as shown in FIG. 3, a laser beam 18 emitted from a laser head 17 positioned substantially directly above the laser beam transmitting portion 16 of the press holding jig 11 is transmitted sequentially through the laser beam transmitting portion 16 of the press holding jig 11 and the laser beam transmitting portion 9 of the lens 3 to eventually be converted on the welding surface 10 of the housing 2 in a predetermined spot diameter, whereby the welding surface 10 of the housing 8 is heated and fused by virtue of irradiation energy of the laser beam 18, and the welding surface 8 of the lens 3 is also then heated and fused by fusion heat generated through the fusion of the welding portion 10, generating a compatible state. Furthermore, the heated and fused portions are cooled, so that the welding surface 10 of the housing 2 and the welding surface 8 of the lens 3 are joined together.

When laser-beam welding the welding surface 10 of the housing 2 and the welding surface 8 of the lens 3 together, in one or more embodiments, a sum tT of the thickness T16 of the laser beam transmitting portion 16 of the press holding jig 11 and the thickness T9 of the laser beam transmitting portion 9 of the lens 3 (=T16+T9) is preferably substantially constant throughout a whole area in a direction A in which the laser beam is scanned. This is because since the diameter of the laser beam 18 is controlled such that the laser beam 18 starts and continues to be contracted from the state where the beam is emitted from the laser head 17 until it produces the predetermined spot diameter on the welding surface 10 of the housing 2, in the event that the distance over which the laser beam transmits through the two laser beam transmitting portions 16, 9 changes, the spot diameter at the welding surface 10 also changes, resulting in a change in irradiation energy from the laser beam 18 received by the welding surface 10, whereby the fusing conditions becomes uneven. Due to this, in the event that the sum tT remains even throughout the whole area in the scanning direction A, there is provided an advantage that the teaching of a robot is facilitated. However, it is not vital that the tT be constant throughout the whole area in the scanning direction, and in the event that the tT can be even at at least a segment of the whole area, the robot teaching for that specific segment can be facilitated.

It is preferable from the above-mentioned fact that, in one or more embodiments, the refraction index of the laser beam transmitting portion 9 of the lens 3 is approximate to that of the laser beam transmitting portion 16 of the press holding jig 11. For example, in the event that the lens is made of acrylic resin, it is preferable that the laser beam transmitting portion 16 of the press holding jig 11 is formed of acrylic resin or a material having a refraction index approximate to that of the acrylic resin.

On the contrary, hypothetically speaking, if the thickness of the laser beam transmitting portion 16 and the thickness of the laser beam transmitting portion 9 are different in the laser beam scanning direction A, while the sum tT of the thicknesses of the two laser beam transmitting portions 16, 9 is the same in the laser beam scanning direction A, and if the refraction indices of both the laser beam transmitting portions 16, 9 are different, the spot diameter on the welding surface 10 becomes different in the scanning direction A. Thus, the irradiation energy resulting on the welding surface 10 needs to be controlled to become uniform in the laser beam scanning direction A by adjusting the irradiation energy of the laser beam 18, the scanning speed thereof and the like. As a result, the needed control have to become complex.

Next, the laser welding of the welding surface 6 of the lens 3 and the welding surface 7 of the lens 2 together is carried out, as shown in FIG. 4, by emitting the laser beam 18 to the protruding portion 5 of the lens 3 obliquely downwards from a position situated obliquely above the protruding portion 5 in such a manner as to be converged on the welding surface 7 of the housing 2 in a predetermined spot diameter and then scanning the laser beam 18 in a direction indicated by an arrow B in FIG. 5. As this occurs, part 5a of the protruding portion 5 of the lens 3 constitutes a laser beam transmitting portion.

The circumferential edge portion of the lens 3 is joined to the circumferential edge portion of the opening in the housing 2 in such a manner as has been described above.

One or more embodiments of the present invention may include one or more following advantages.

When applied to joining together a housing and a lens of a vehicle lamp, in particular, a large vehicle lamp, one or more embodiments of the present invention can ensure the required joining of the components without damaging the external appearance of the vehicle lamp.

The vehicle lamp manufacturing method according to one or more embodiments of the present invention for fixing a lens to a housing that is opened in a front side thereof via laser-beam welding in such a manner as to cover the front side opening, includes the steps of bringing a lens, around a full circumference of which a laser beam transmitting portion and a welding portion are formed, into abutment with a housing, around a full circumference of which a welding portion is formed, at the welding portions, pressing the lens with a press holding jig having a laser beam transmitting portion to bring the welding portion of the lens into abutment with the welding portion of the housing, and emitting a laser beam to a location where the welding portion of the lens is in abutment with the welding portion of the housing while the laser beam so emitted is made to be transmitted through the laser beam transmitting portion of the press holding jig and the laser beam transmitting portion of the lens at at least part of the location, wherein in a segment where the part of the location continues where the laser beam is transmitted through the laser beam transmitting portion of the press holding jig and the laser beam transmitting portion of the lens, a sum of the thickness of the laser beam transmitting portion of the press holding jig and the thickness of the laser beam transmitting portion of the lens remains substantially constant in a direction in which the laser beam is scanned.

In addition, in one or more embodiments of the present invention, the vehicle lamp manufacturing apparatus for fixing a lens to a housing made to open in a front side thereof via laser-beam welding in such a manner as to cover the front side opening, comprises a press holding jig for bringing a lens, around a full circumference of which a laser beam transmitting portion and a welding portion are formed, into abutment with a housing, around a full circumference of which a welding portion is formed, at the welding portions, wherein, when emitting a laser beam to a location where the welding portion of the lens is in abutment with the welding portion of the housing, the press holding jig allows the laser beam so emitted to be transmitted through the laser beam transmitting portion of the press holding jig and the laser beam transmitting portion of the lens at at least part of the location, and wherein in a segment where the part of the location continues where the laser beam is transmitted through the laser beam transmitting portion of the press holding jig and the laser beam transmitting portion of the lens, a sum of the thickness of the laser beam transmitting portion of the press holding jig and the thickness of the laser beam transmitting portion of the lens becomes substantially constant in a direction in which the laser beam is scanned.

Consequently, in one or more embodiments of the present invention, in the segment where the part of the location continues where the laser beam is transmitted through the laser beam transmitting portion of the press holding jig and the laser beam transmitting portion of the lens, the distance at which the laser beam is transmitted through the laser beam transmitting portion of the press holding jig and the laser beam transmitting portion of the lens becomes substantially constant in a direction in which the laser beam is scanned. Due to this, in the event that the output and scanning speed of the laser beam are constant, the diameter of the spot at the joining portion between the lens and the housing becomes constant. Namely, the irradiation energy at the joining portion between the lens and the housing becomes constant. Consequently, the control is facilitated of the irradiation energy at the joining portion between the lens and the housing, whereby a laser-beam welding with good quality can be implemented. In addition, the teaching of a robot is also facilitated when attempting to perform the laser beam emitting process using the robot.

According to one or more embodiments of the present invention, since the lens is pressed towards the housing, so that the welding portion of the lens is brought into abutment with the welding portion of the housing in such a state that a surface contact portion of the press holding jig is brought into surface contact with substantially the whole of a lens surface, which is curved, the welding portion of the lens and the welding portion of the housing are brought into abutment with each other in an ensured fashion.

According to one or more embodiments of the present invention, since the welding portion of the lens is brought into abutment with the welding portion of the housing in such a state that a circumferential edge portion of the lens is positioned by a positioning portion formed around a full circumference of a circumferential edge portion of the press holding jig, there occurs no positional deviation between the welding portion of the lens and the welding portion of the housing, so that the welding portions of these components are brought into abutment with each other in an ensured manner.

According to one or more embodiments of the present invention, since the press holding jig is formed of a material having an approximate refraction index to that of a material for the lens, even when the thickness of the laser beam transmitting portion of the press holding jig and the thickness of the laser beam transmitting portion of the lens changes relatively, in the event that the sum of the thicknesses of the two components is substantially the same, the spot of the laser beam at the joining portion between the lens and the housing becomes substantially the same. Therefore, the control of irradiation energy at the joining portion between the lens and the housing can be facilitated.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

1. A vehicle lamp manufacturing method for laser-beam welding a lens to a housing, comprising:
disposing the lens onto the housing, wherein the lens comprises a laser beam transmitting portion provided around a full circumference of the lens and a welding portion of a lens provided around a full circumference of the lens, and wherein the housing comprises a welding portion provided around a full circumference of the housing;
pressing the lens with a press holding jig so as to bring the welding portion of the lens into abutment with the welding portion of the housing, wherein the press holding jig comprises a laser beam transmitting portion; and
emitting a laser beam to a location where the welding portion of the lens is in abutment with the welding portion of the housing,
wherein the laser beam is transmitted through the laser beam transmitting portion of the press holding jig and the laser beam transmitting portion of the lens to at least a part of the location.

2. The vehicle lamp manufacturing method according to claim 1, wherein, in a segment where the part of the location continues, a sum of a thickness of the laser beam transmitting portion of the press holding jig and a thickness of the laser beam transmitting portion of the lens is substantially constant in a direction in which the laser beam is scanned.

3. The vehicle lamp manufacturing method according to claim 1, wherein the pressing the lens with the press holding jig so as to bring the welding portion of the lens into abutment with the welding portion of the housing is performed such that a surface contact portion of the press holding jig is brought into surface contact with substantially a whole of a curved surface of the lens.

4. The vehicle lamp manufacturing method according to claim 1, wherein the pressing holding jig further comprises a positioning portion provided around a full circumference of a circumferential edge portion of the press holding jig, the method further comprising:
positioning a circumferential edge portion of the lens with the positioning portion of the press holding jig so as to bring the welding portion of the lens into abutment with the welding portion of the housing.

5. The vehicle lamp manufacturing method according to claim 1, wherein a refraction index of a material for the press holding jig and a refraction index of a material for the lens are substantially equal.

6. The vehicle lamp manufacturing method according to claim 5, wherein the material for the press holding jig is an acrylic resin.

7. The vehicle lamp manufacturing method according to claim 1, further comprising:
forming at least a part of the location by an abutment of inclined-plane surfaces.

8. The vehicle lamp manufacturing method according to claim 1, further comprising:
forming at least a part of the location by an abutment of substantially horizontal surfaces.

9. The vehicle lamp manufacturing method according to claim 1, wherein the lens covers a front side opening of the housing, and an external appearance of the vehicle lamp is not damaged by the laser-welding of the lens to the housing.

10. A vehicle lamp manufacturing apparatus for laser-beam welding a lens to a housing, comprising:
a press holding jig for bringing a laser beam transmitting portion and a welding portion of the lens into abutment with a welding portion of the housing, wherein the laser beam transmitting portion and the welding portion of the lens are provided around a full circumference of the lens, and the welding portion of the housing is provided around a full circumference of the housing, the press holding jig comprising a laser beam transmitting portion,
wherein a laser beam is transmitted through the laser beam transmitting portion of the press holding jig and the laser beam transmitting portion of the lens when the laser beam is emitted to at least a part of a location where the welding portion of the lens is in abutment with the welding portion of the housing.

11. The vehicle lamp manufacturing apparatus according to claim 10, wherein, in a segment where the part of the location continues, a sum of a thickness of the laser beam transmitting portion of the press holding jig and a thickness of the laser beam transmitting portion of the lens is substantially constant in a direction in which the laser beam is scanned.

12. The vehicle lamp manufacturing apparatus according to claim 10, wherein the press holding jig presses the lens so as to bring the welding portion of the lens into abutment with the welding portion of the housing is performed such that a surface contact portion of the press holding jig is brought into surface contact with substantially a whole of a curved surface of the lens.

13. The vehicle lamp manufacturing apparatus according to claim 10, the pressing holding jig further comprising a positioning portion provided around a full circumference of a circumferential edge portion of the press holding jig, wherein a circumferential edge portion of the lens is positioned with the positioning portion of the press holding jig so as to bring the welding portion of the lens into abutment with the welding portion of the housing.

14. The vehicle lamp manufacturing apparatus according to claim 10, wherein a refraction index of a material for the press holding jig and a refraction index of a material for the lens are substantially equal.

15. The vehicle lamp manufacturing apparatus according to claim 14, wherein the material for the press holding jig is an acrylic resin.

16. The vehicle lamp manufacturing apparatus according to claim 10, wherein at least a part of the location is formed by an abutment of inclined-plane surfaces.

17. The vehicle lamp manufacturing apparatus according to claim 10, wherein at least a part of the location is formed by an abutment of substantially horizontal surfaces.

18. The vehicle lamp manufacturing apparatus according to claim 10, wherein the lens covers a front side opening of the housing, and an external appearance of the vehicle lamp is not damaged by the laser-welding of the lens to the housing.
